(19) United States
(12) Patent Application Publication
(10) Pub. No.: US 2020/0067152 A1
(43) Pub. Date: Feb. 27, 2020

(54) BATTERY COOLING DEVICE FOR VEHICLE

(71) Applicants: Hyundai Motor Company, Seoul (KR); Kia Motors Corporation, Seoul (KR)

(72) Inventor: Yoon Cheol Jeon, Suwon (KR)

(21) Appl. No.: 16/183,132

(22) Filed: Nov. 7, 2018

(30) Foreign Application Priority Data
Aug. 21, 2018 (KR) 10-2018-0097232

(51) Int. Cl. H01M 10/659; H01M 10/613; H01M 10/6554; H01M 10/625

(52) U.S. Cl. CPC H01M 10/659; H01M 10/625; H01M 10/6554; H01M 10/613

(57) ABSTRACT

A battery cooling device for a vehicle is provided to cool a battery cell. The device includes a phase change material (PCM) that cools the battery cell and is disposed to exchange heat with the battery cell and cooling water for cooling the phase change material is disposed to exchange heat with the phase change material. Thus, the phase change material is heated by heat generation of the battery cell and at the same time the phase change material is cooled by heat absorption of the cooling water thereby facilitating continuous phase change of the phase change material.

### CROSS REFERENCE TO RELATED APPLICATION

The present application claims priority to Korean Patent Application No. 10-2018-0097232, filed Aug. 21, 2018, the entire contents of which is incorporated herein for all purposes by this reference.

### BACKGROUND

### Field of the Invention

The present invention relates generally to a battery cooling device for a vehicle and, more particularly, to a battery cooling device for a vehicle that cools a battery cell using a phase change material.

### Description of the Related Art

Recently, an electric vehicle requires long-distance driving, high-power/high-performance driving, and rapid charging. A battery system as an energy source of the electric vehicle has high levels of electric current flowing in battery cells thereof, which causes heat greater than the capacity of conventional battery cooling device installed in existing electric vehicles. Since the heat produced in the battery cells has an adverse effect on battery life, the heat is required to be maintained at a predetermined temperature range.

For temperature maintenance of the battery cells, existing electric vehicles use an air cooling system or a water cooling system. In particular, the air cooling system provides air within a vehicle cabin to the battery system using a cooling fan to thus cool the battery cells. The water cooling system provides a coolant cooled by an additional battery chiller in a front of the vehicle to the battery system using a pump to thus cooling the battery cells. In particular, the battery chiller operates in cooperation with a radiator or an air conditioner compressor. However, an electric vehicle uses high levels of electric current for long-distance driving and high-power/high-performance driving, and accordingly even though the electric vehicle uses a water cooling system having cooling performance greater than cooling performance of an air cooling system, increasing the capacities of the air conditioner compressor (or the radiator) and the battery chiller to cool heat produced in the battery cells is unavoidable.

### SUMMARY

The present invention provides a battery cooling device for a vehicle that cools a battery cell using a phase change material (PCM). The PCM may exchange heat with the battery cell and cooling water for cooling the phase change material may exchange heat with the phase change material to heat the phase change material by heat generation of the battery cell. At the same time the phase change material may be cooled by heat absorption of the cooling water thereby facilitating continuous phase change of the phase change material. The battery cooling device may be configured to cool the battery cells by absorbing the heat during the melting of the phase change material (PCM) inside the cell covers. Additionally, the cell covers are in contact with cooling channel in which cooling water flows through to cool the phase change material thereby facilitating continuous phase change of the phase change material.

Accordingly, the present invention provides a battery cooling device for a vehicle by which a battery module having a plurality of battery cells is cooled, the device may include: a plurality of cell covers disposed between at least some battery cells of the plurality of battery cells covers and including a phase change material heated by heat generation of the battery cells that are adjacent to the cell covers; and a cooling plate disposed to exchange heat with the phase change material via the cell covers and allowing cooling water for cooling the phase change material to flow therethrough.

According to an exemplary embodiment of the present invention, each of the cell covers may include a first plate disposed between the battery cells that are adjacent to each other, and the phase change material may be disposed inside the first plate. Specifically, the first plate may include therein an accommodation chamber (e.g., a space) in which the phase change material may be filled, and the phase change material may be disposed between battery cells that are adjacent to each other. In other words, the first plate may be in contact with outer surfaces of the battery cells that are adjacent to each other, and the phase change material in the accommodation chamber may be disposed to exchange heat with the entire outer surfaces of the adjacent battery cells via the first plate. In addition, the cell cover may extend vertically from the first plate and may include a second plate disposed on a top surface of the cooling plate, and the second plate may be disposed on a bottom surface of each of the battery cells.

In addition, according to an exemplary embodiment of the present invention, the cooling plate may be disposed to exchange heat due to contact with the cell cover. The cooling plate may include a plurality of cooling water channels, and the cooling water may flow in each of the cooling water channels to solidify the phase change material melted and liquefied by the heat generation of the battery cells. Each of the cooling water channels may extend in the arrangement direction of the battery cells.

According to the battery cooling device of the present invention as described above, since the phase change material may be heated by the heat generation of the battery cell and at the same time cooled by the cooling water, the phase change (solid→liquid) of the phase change material during the cooling of the battery cell may be repeated continuously. Therefore, while the battery cell is cooled by the phase change material, the phase change material may continuously generate latent heat due to the phase change, thereby effectively cooling the battery cell. An amount of heat that the phase change material may absorb from the battery cell increases several times when the battery cell is cooled using latent heat generated by the phase change, rather than when the battery cell is cooled using sensible heat of a single phase. Therefore, when using the battery cooling device of the present invention, it is unnecessary to increase capacities of the air conditioner compressor and the chiller unlike the water-cooling system of the related art.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1 and 2 are views showing a battery cooling device for a vehicle according to an exemplary embodiment of the present invention;

FIG. 3 is a view seen from A-A in FIG. 1 according to an exemplary embodiment of the present invention; and

FIG. 4 is a view showing a heat transfer path in a battery module to which a battery cooling device for a vehicle is applied according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referral to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings.

When a refrigerant in a liquid state is used for cooling a battery module that is a power source of an electric vehicle, the refrigerant absorbs heat generated from the battery module when the refrigerant flows through a refrigerant channel, thereby cooling the battery module. When the refrigerant is in a liquid state, the refrigerant cools the battery module while being vaporized by heat generated in the battery module, and then the refrigerant in a gas state and absorbs the heat of the battery module to cool the battery module. The refrigerant has a substantial difference between an amount of heat (e.g., first amount of heat) capable of cooling the battery module using the latent heat generated by evaporation when in a liquid state, and an amount of heat (e.g., second amount of heat) capable of cooling the battery module using the sensible heat of a single phase when in a gaseous state. Although the difference between the amounts of heat may vary depending on types of the refrigerant, the first amount of heat is about several times the second amount of heat since cooling the battery module by phase change without changing the temperature of the coolant has greater cooling effect than cooling the battery module only by changing the temperature without phase change of the coolant.

In other words, the heat transfer may be sufficiently performed at the moment when the phase change occurs in the refrigerant, and the heat transfer efficiency may be rapidly reduced after the phase change (liquid→gas) occurs. Therefore, there is a difference between the amount of heat absorbed by the battery module before the refrigerant is vaporized and the amount of heat absorbed after the refrigerant is vaporized, and the cooling of the battery module is minimally performed after the refrigerant is vaporized. In other words, the cooling performance of the refrigerant is significantly reduced when the refrigerant is in a gaseous state as compared with when the refrigerant is in a liquid state. Further, since the refrigerant may be heated by the heat generated in the battery cell even after the refrigerant is changed to the gaseous state, it may be difficult to return the refrigerant to an original phase.

More specifically, a substantial difference occurs in the amount of cooling between the battery cell in which the cooling is performed before the refrigerant is vaporized and the battery cell in which the cooling is performed after the refrigerant is vaporized, among the battery cells of the battery module. When the battery cell is to be cooled after the refrigerant is vaporized, the cooling is minimally performed, whereby the uniform cooling of the battery cells of the battery module may be difficult. Therefore, in the present invention, a phase change material (PCM) for cooling the battery cell may be disposed to exchange heat with the battery cell, and cooling water for cooling the phase change material may be disposed to exchange heat with the phase change material. In particular, the phase change material may be cooled by heat absorption of the cooling water when the phase change material is heated by the heat generation of the battery cell. Accordingly, the phase change material may cause a continuous phase change while being heated by the battery cell, and thus cool the battery cell using the latent heat according to the phase change (solid→liquid). In other words, the phase change material may maintain the cooling performance for the battery cell at a particular level while the phase change material is heated by the battery cell.

When a portion (e.g., a first portion) of the phase change material is melted and liquefied by the heat generation of the battery cell, the battery cell may be cooled while another portion of the phase change material is liquefied, and some of the liquefied phase change material may be solidified again by the heat absorption of the cooling water while the another portion (e.g., a second portion) of the phase change material cools the battery cell. More specifically, according to the present invention, when the phase change occurs in the phase change material for cooling the battery cell, the phase change material may be returned back to an original phase, thereby maintaining cooling performance of the phase change material during the cooling of the battery cell.

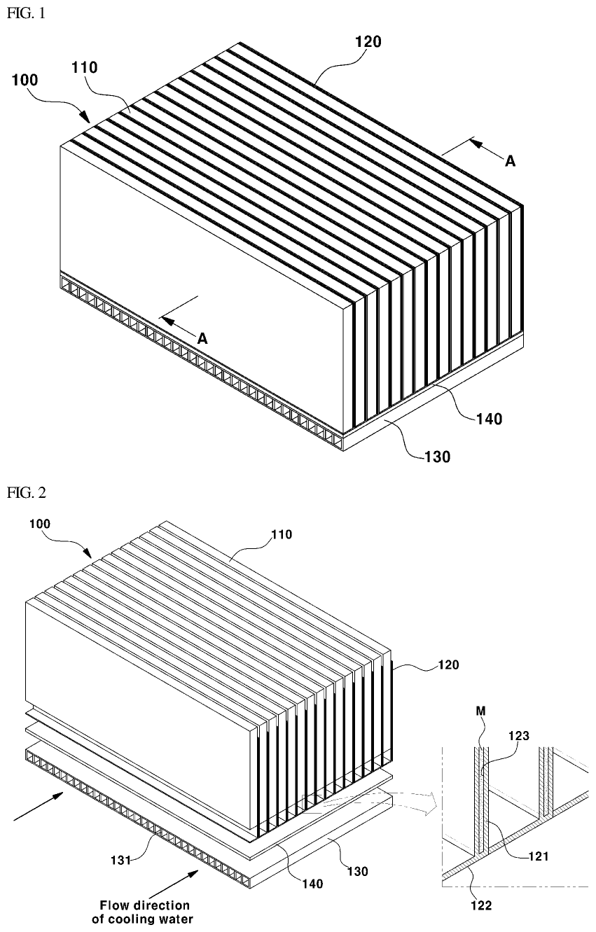

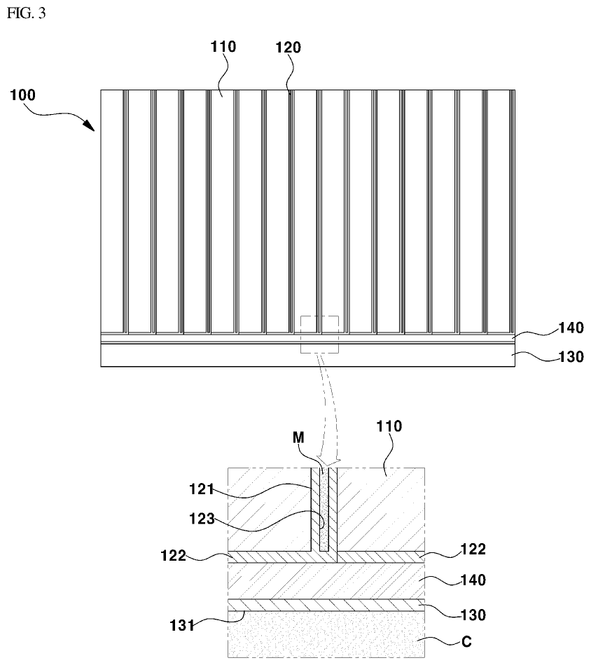

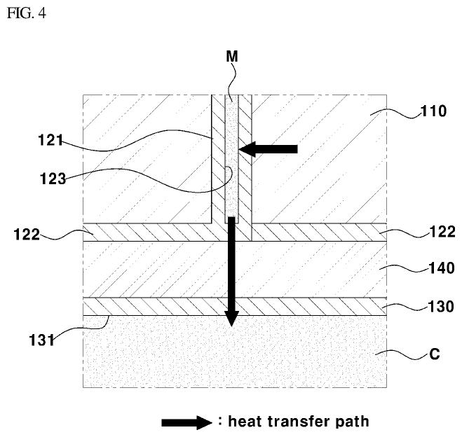

FIGS. 1 and 2 are views showing a battery cooling device for a vehicle according to an exemplary embodiment of the present invention; FIG. 3 is a view seen from A-A in FIG. 1; and FIG. 4 is a view showing a heat transfer path in a battery module to which a battery cooling device for a vehicle is applied according to an exemplary embodiment of the present invention.

As shown in FIGS. 1 to 3, the battery cooling device according to the present invention is a device for cooling a battery module 100 having a plurality of battery cells 110, and the battery module 100 may be continuously cooled using a latent heat of fusion of a phase change material M. The battery module 100 may be configured by combining a plurality of battery cells 110 electrically connected in series or in parallel. The plurality of battery cells 110 may be arranged adjacent to each other in one direction, and each of the battery cells 110 may be structurally separated from other battery cells and supported by a cell cover 120, as a minimum unit for generating electricity.

The cell cover 120 may be disposed outside each of the battery cells 110 and may include the phase change material M heated by heat generation of each of the battery cells 110. Specifically, the cell cover 120 may include a first plate 121 and a second plate 122. The first plate 121 may be disposed between battery cells 110 adjacent to each other and may be formed of a flat plate having a cross sectional area that corresponds to the contact surface between the adjacent battery cells 110 or a flat plate having a cross sectional area slightly greater than the contact surface. The first plate 121 may be entirely disposed between the adjacent battery cells 110 rather than partially disposed between adjacent battery cells 110. The first plate 121 may also extend in a direction perpendicular to an arrangement direction of the battery cells 110. The first plate 121 may be disposed between every adjacent battery cells 110.

The phase change material M may be disposed inside the first plate 121. Accordingly, the first plate 121 may include therein an accommodation chamber (e.g., a space or void) 123 in which the phase change material M may be filled. The space 123 may extend in a direction perpendicular to the arrangement direction of the battery cells 110. The space 123 may have a cross sectional area that corresponds to the contact surface of the adjacent battery cells 110 or have a cross sectional area slightly less than the contact surface. Accordingly, the phase change material M may be distributed and disposed entirely between adjacent battery cells 110. The phase change material M may be inserted into the space 123 in a solid state or filled in the space 123 in a liquid state. The phase change material M is a material that maintains a solid state at a room temperature, and may undergo a solidifying process when being injected into the space 123 in a liquid state.

The second plate 122 may extend vertically from the first plate 121 to be integrally formed therewith. In particular, the second plate 122 may extend in the stacking direction (e.g., arrangement direction) of the battery cells 110 at the lower end of the first plate 121. In other words, the second plate 122 may be arranged in a direction perpendicular to the first plate 121. The second plate 122 may be disposed on the top surface of the cooling plate 130 and the bottom surface of the battery cell 110. The cell cover 120 including the first plate 121 and the second plate 122 may have an “L”-shaped cross section. The cell cover 120 may be disposed outside each of battery cells 110, and one cell cover 120 may accommodate one battery cell 110 in an “L”-shape. Particularly, the plurality of cell covers 120 may be arranged in the arrangement direction of the battery cells 110. Accordingly, the second plates 122, in contact with the bottom surface of each of the battery cells 110, may be continuously arranged in the arrangement direction of the battery cells 110, on the bottom surface of the battery module 100.

Although the cell cover 120 may be disposed between all the adjacent battery cells 110 in the examples of FIGS. 1 to 3, this is merely an exemplary embodiment, and the present invention is not limited to this example. For example, the cell cover 120 containing the phase change material M may not be disposed between some battery cells. However, considering the cooling performance and the battery charge/discharge performance, the cell cover 120 including the phase change material M be disposed between all the battery cells 110 as shown in FIGS. 1 to 3.

The cooling plate 130 for cooling the phase change material M accommodated in the cell cover 120 may be disposed below the cell cover 120 (e.g., below the second plate). In addition, cooling water C for absorbing heat released from the phase change material M may flow through the cooling plate 130. Particularly, the cooling plate 130 may include a plurality of cooling water channels 131 in which the cooling water C may flow. The plurality of cooling water channels 131 may be arranged in a direction perpendicular to a stacking direction (i.e., an arrangement direction) of the battery cells 110, and each of the cooling water channels 131 may extend in the arrangement direction of the battery cells 110. Additionally, the cooling water C flowing in each of the cooling water channels 131 may be discharged from the cooling water channel 131, cooled outside the cooling plate 130, and then supplied to the cooling water channel 131 back.

Further, the cooling plate 130 may be disposed to exchange heat with the cell cover 120 to allow the heat released from the phase change material M in the cell cover 120 to be absorbed by the cooling water. In other words, the cooling plate 130 may be configured to receive and absorb the heat of the phase change material M through the cell cover 120. The cooling plate 130 may be arranged to exchange heat with the cell cover 120 due to contact therebetween. In other words, the cooling plate 130 may be disposed to be in contact with the cell cover 120, to thus cool the phase change material M inside the cell cover 120.

The cooling plate 130 disposed below the cell cover 120 may be disposed on the bottom surface of the battery cell 110 with the second plate 122 of the cell cover 120 disposed in between. In other words, the cooling plate 130 may be disposed to be in contact with the battery cell 110 via the second plate 122 of the cell cover 120. Accordingly, the battery cells 110 may transfer the heat released from the battery cells 110 to the cooling plate 130 via the second plate 122. The amount of heat of the battery cell 110 transferred to the cooling plate 130 via the second plate 122 is minimal compared to the amount of heat of the battery cell 110 transferred to the cooling plate 130 through the phase change material M. In other words, the cooling plate 130 may be arranged to allow the heat released from the phase change material M by the cell cover 120 to be absorbed and at the same time the heat released from the battery cell 110 may be absorbed. In other words, the cooling plate 130 may be disposed to be in contact with the cell cover 120, thereby cooling the battery cell 110 and the phase change material M simultaneously.

The cell cover 120 may be formed of a metal material that is preferable to heat conduction and may be formed of a metal material having high heat conductivity such as aluminum. In addition, an interface sheet 140 may be disposed between the second plate 122 of the cell plate 120 and the cooling plate 130 to improve the heat exchange efficiency between the cell cover 120 and the cooling plate 130. The second plate 122 and the cooling plate 130 have surfaces capable of being in surface-contact with each other. However, since the second plate 122 and the cooling plate 130 may have a microscale rough surface and interfacial gaps may be formed between the second plate 122 and the cooling plate 130. Therefore, when the second plate 122 and the cooling plate 130 make contact with each other, the actual contact area is minimal.

Additionally, since the interfacial gaps may be filled with air having a relatively low thermal conductivity, heat transfer through the interface (contact surface) between the second plate 122 and the cooling plate 130 may not be performed smoothly. To smoothly transfer heat between the cell cover 120 and the cooling plate 130, the interface sheet 140 may be disposed between the second plate 122 and the cooling plate 130 to fill interfacial gaps between the cell cover and the cooling plate 130. The interface sheet 140 may fill the gaps between the second plate 122 and the cooling plate 130 to minimize a thermal contact resistance between the second plate 122 and the cooling plate 130 and facilitate the thermal transfer between the second plate 122 and the cooling plate 130. In other words, the interface sheet 140 may be disposed in contact between the second plate 122 and the cooling plate 130, thereby improving the heat transfer efficiency between the cell cover 120 and the cooling plate 130. In particular, the interface sheet 140 may be formed of a thermal interface material (TIM) to minimize the resistance in heat transfer.

The phase change material M may be used with a material that is changed from a solid to a liquid and generates latent heat of fusion. In other words, the phase change material M may be used with a material that is maintained at a solid state at room temperature and changed to a liquid state when being heated by the battery cell 110. The phase change material M may also be made of a material having electrical insulation, whereby electrical safety may be secured even when electricity leakage to the outside of the cell cover 120 occurs. In the present invention, the phase change material M accommodated in the cell cover 120 may be an intermediate form in which a phase change material in a liquid state is mixed with a phase change material in a solid state, and may mean a material that repeatedly exhibits heat absorption and heat generation characteristics of absorbing heat when the temperature around the cell cover 120 increases and releasing heat when the temperature around the cell cover 120 decreases.

Particularly, the phase change material M in the present invention may be a material that may be changed in phase within the operating temperature range of the battery cell to effectively contribute to securing the cooling performance of the battery cell for a vehicle. For example, the melting point of the phase change material M may be within the range of about 30° C. to 45° C. When using the phase change material having the melting point mentioned above, the phase change material may stably maintain the temperature of the battery cell 110 by the latent heat of fusion of the phase change material before the overheating of the battery cell 110 occurs. In particular, in the case of most lithium ion battery cells applied to a vehicle battery cell, the maximum temperature must be maintained within a range of about 45° C. to 50° C. to ensure a desired life span. Additionally, in the case of the phase change material having a melting point in the above range (e.g., about 30° C. to 45° C.), the thermal energy absorbed by the phase change material is greater than the thermal energy generated in the battery cell 110 and thus, the temperature of the battery cell 100 may be maintained at the melting point or less.

Specifically, the phase change material M may be any one selected from the group consisting of an organic phase change material and an inorganic phase change material, or may be a mixture of two or more selected. The organic phase change material may include a paraffin based phase change material and a non-paraffin based phase change material. The paraffin based phase change material may include a paraffin wax having a melting point of about 37° C. and the non-paraffin based phase change material may include Camphenilone (melting point: about 39° C.), Caprylone (melting point: about 40° C.), and the like. The inorganic phase change material may include salt hydrates, metallics, and eutectics; and the metallics may include gallium or the like having a melting point of about 30° C. The eutectic is a solid mixture in which the liquid phase formed through melting shows the same composition as the original solid phase, and may include gallium-gallium antimony eutectics (melting point: about 29.8° C.) and the like.

When being heated by the battery cell 110, the phase change material M absorbs the sensible heat of the battery cell 110 without the phase change and thus increases in temperature until the melting point is reached. When being heated by the battery cell 110 to reach the melting point, the phase change material M undergoes a phase change from a solid state to a liquid state. The phase change material M absorbs the heat of the battery cell 110 due to the latent heat of fusion even while the phase change occurs, but the temperature of the phase change material M is maintained constant. In other words, when the phase change material M increases in temperature due to the heat generation of the battery cell 110 to reach the melting point, a part of the phase change material M begins to melt and may be maintained at the temperature of the melting point until the phase change material M is completely melted.

The phase change material M may absorb thermal energy greater than a maximum thermal energy generated in the battery cell 110 when a phase change occurs due to heat generation of the battery cell 110. Accordingly, the battery cell 110 cooled by the latent heat of fusion according to the phase change of the phase change material M may be maintained at the temperature below the melting point of the phase change material M.

In particular, the cooling water C may continuously cool the phase change material M regardless of whether the phase change material M is changed in phase. In other words, when the battery cell 110 is cooled by the sensible heat of the phase change material M, and also when the battery cell 110 is cooled by the latent heat of the phase change material M, may the cooling water C continuously cool the phase change material M. Accordingly, at least a part of the phase change material M may maintain a solid state, and as a result, the phase change material M may maintain a phase change due to heat generation of the battery cell 110, and the battery cell 110 may be continued to be cooled by the latent heat of the phase change material M.

Moreover, a heat transfer path in the battery module 100 will be described with reference to FIG. 4. The arrows shown in FIG. 4 indicate the heat transfer direction of the battery module 100 based on the heat generated by the battery cells 110. As shown in FIG. 4, when the battery cell 110 is heated to a high temperature by rapid charging or the like, heat emitted from the battery cell 110 is transferred to the phase change material M via the first plate 121 of the cell cover 120 and the heat of the battery cell 110 absorbed by the phase change material M is transferred to the cooling plate 130 via the second plate 122 of the cell cover 120 and the interface sheet 140. The heat of the battery cell 110 transferred to the cooling plate 130 may be absorbed by the cooling water C and thus, the cooling of the phase change material M may be continuously performed by the cooling water C.

Considering the heat transfer path of the battery module 100 based on heat absorption of the cooling water C, the heat transfer may be performed in order of cooling water C of the cooling plate 130→the cell cover 120→the phase change material M→battery cell 110. The phase change material M may generate latent heat of fusion when being changed from a solid phase to a liquid phase due to the heat of the battery cell 110 and is returned back from the liquid phase to the solid phase by the cooling water C. As this phase change process is repeated, the battery cell 110 may be continuously cooled by the latent heat of fusion of the phase change material M. In other words, the battery cooling device of the present invention may return the phase change material M melted by the heat generation of the battery cell 110 back to a solid state, to allow the phase change of the phase change material M to occur continuously, whereby the cooling of the battery cell 110 may be continued using the latent heat of the phase change material M.

While the present invention has been particularly shown and described with reference to exemplary embodiments thereof, it is to be understood that the scope of the present invention is not limited to the disclosed exemplary embodiments. Various modifications and improvements carried out by those skilled in the art using the basic concept of the present invention as defined in the following claims are also included in the scope of the present invention.

What is claimed is:

1. A battery cooling device for a vehicle that cools a battery module including a plurality of battery cells, comprising:
a plurality of cell covers disposed between at least some battery cells of the plurality of battery cells covers and including a phase change material heated by heat generation of the battery cells that are adjacent to the cell covers; and
a cooling plate disposed to exchange heat with the phase change material via the cell covers, wherein cooling water for cooling the phase change material flow through the cooling plate.

2. The device of claim 1, wherein each of the cell covers includes a first plate disposed between the battery cells that are adjacent to each other, and the phase change material is disposed inside the first plate.

3. The device of claim 2, wherein the first plate includes therein a space in which the phase change material is filled.

4. The device of claim 3, wherein the first plate is in contact with outer surfaces of the battery cells that are adjacent to each other, and the phase change material filled in the space is disposed to exchange heat with the entire outer surfaces of the adjacent battery cells via the first plate.

5. The device of claim 2, wherein the cell cover extends vertically from the first plate and includes a second plate that is disposed on a top surface of the cooling plate.

6. The device of claim 5, wherein the second plate is disposed on a bottom surface of each of the battery cells.

7. The device of claim 1, wherein the cooling plate is disposed to exchange heat due to contact with the cell cover.

8. The device of claim 1, wherein the cooling plate includes a plurality of cooling water channels, and the cooling water flows through each of the cooling water channels to solidify the phase change material liquefied by the heat generation of the battery cells.

9. The device of claim 8, wherein each of the cooling water channels extends in the arrangement direction of the battery cells.

10. The device of claim 1, wherein an interface sheet is disposed between the cell cover and the cooling plate to fill interfacial gaps of the cell cover and the cooling plate.

11. The device of claim 1, wherein the phase change material is changed from a solid phase to a liquid phase to generate a latent heat of fusion.

12. The device of claim 11, wherein the phase change material has a melting point of about 30° C. to 45° C.

13. The device of claim 1, wherein the phase change material is any one selected from the group consisting of: an organic phase change material, an inorganic phase change material, and a mixture of two or more selected.

14. The device of claim 13, wherein the organic phase change material includes a paraffin based phase change material and a non-paraffin based phase change material.

15. The device of claim 13, wherein the inorganic phase change material includes salt hydrates, metallics, and eutectics.

16. The device of claim 1, wherein the phase change material is a paraffin wax.
